(19) United States
(12) Patent Application Publication
(10) Pub. No.: US 2020/0412273 A1
(43) Pub. Date: Dec. 31, 2020

(54) CASCADED MODULAR MULTILEVEL CONVERTER FOR MEDIUM-VOLTAGE POWER ELECTRONICS SYSTEMS

(71) Applicant: NORTH CAROLINA STATE UNIVERSITY, Raleigh, NC (US)

(72) Inventors: Srdjan LUKIC, Raleigh, NC (US); Jehyuk WON, Raleigh, NC (US); Srdjan SRDIC, Raleigh, NC (US); Xinyu LIANG, Raleigh, NC (US)

(21) Appl. No.: 16/975,743

(22) PCT Filed: Feb. 22, 2019
(86) PCT No.: PCT/US2019/019173

§ 371 Date: Aug. 26, 2020

Related U.S. Application Data
(60) Provisional application No. 62/635,830, filed on Feb. 27, 2018.

(51) Int. Cl. H02M 7/483; H02M 3/335; H02M 7/219

(52) U.S. Cl. CPC H02M 7/483; H02M 3/33576; H02M 2001/0003; H02M 2007/4835; H02M 7/219

(57) ABSTRACT

A cascaded modular multilevel converter for medium-voltage power electronics systems is disclosed. The converter can be used in applications such as an auxiliary power supply for medium-voltage (MV) power electronics system, or a unidirectional SST which powers a home (where very light load conditions are experienced when the home is unoccupied or during the night). Unlike the traditional solutions which use a grid-frequency, bulky, and heavy power transformers, the disclosed converter can operate at higher switching frequencies, weigh less, and provide a higher power density than other approaches. Additionally, the disclosed converter features an internal capacitor voltage balancing and can achieve power factor correction (PFC) using predictive control.

### CROSS-REFERENCE TO RELATED APPLICATION

This application claims priority to and benefit of U.S. provisional patent application serial number 62/635,830 filed Feb. 27, 2018, which is fully incorporated by reference and made a part hereof.

### GOVERNMENT SUPPORT

This invention was made with government support under grant number 1610074 awarded by the National Science Foundation and grant number DE-EE0006521 awarded by the Department of Energy. The government has certain rights in the invention.

### FIELD OF THE INVENTION

The present disclosure relates to power electronics systems and more specifically, to a cascaded modular multilevel converter for medium-voltage (MV) power electronics systems.

### BACKGROUND

The most challenging requirement for power electronic systems connected to MV distribution line and supplying low-voltage loads is providing a high step-down ratio in a reasonably simple, compact and cost-effective way.

A cascaded modular multilevel power electronic converter disclosed here may meet this requirement. The disclosed power electronic converter can convert a single-phase medium voltage at its input to a regulated DC voltage at its output. An embodiment of a power electronic converter is disclosed in a previously filed provisional application (i.e., U.S. Prov. Pat. App. No. 62504247), now published as PCT application PCT/US2018/031903, international publication number W02018208991A1, which is fully incorporated by reference. The converter disclosed herein can be used in similar applications as described in this PCT application.

The present disclosure embraces an alternate topology for a modular multilevel series-parallel converter (MMSPC) that offers the advantage of good operating performance under light load conditions. Light load performance is important for applications such as an auxiliary power supply for a MV power electronics system, or a unidirectional solid-state transformer (SST) which powers a home (where very light load conditions are experienced when the home is unoccupied or during the night).

### SUMMARY

In one aspect, the present disclosure embraces a power electronic converter that offers a variety of advantages. The disclosed power electronic converter offers an advantage of high step-down ratio and power factor correction (PFC) function. Another advantage is the disclosed power electronic converter has excellent partial power performance, which is a major problem in other topologies. Another advantage is that the disclosed power electronic converter uses less switches than other topologies and limits the voltage stress on the switch to the voltage across the capacitor. Another advantage is that the disclosed power electronic converter offers natural balancing of the capacitors' voltage due to the existence of a parallel mode (i.e., a mode in which the capacitors are connected in parallel). Another advantage is that the disclosed power electronic converter is scalable and can be extended to an arbitrary number of levels, thereby allowing the disclosed power electronic converter to connect to very high voltages. Another advantage is that the disclosed power electronic converter provides a simple way to implement predictive control for improved PFC performance. Details of the predicative control may be found in IEEE APEC conference (March 4-8, 2018, San Antonio, Tex.) manuscript “Auxiliary Power Supply for Medium Voltage Power Electronics Systems,” by Won et al., DOI: 10.1109/APEC.2018.8341005, which is fully incorporated by reference. This manuscript describes the topology of the power electronic converter of the present disclosure, the implementation of the converter in a power supply, and the predictive control of the converter to achieve power factor correction.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1A schematically illustrates a conventional MMSPC topology with 3 modules and a plurality of MOSFET switches.

FIG. 1B schematically illustrates the MMSPC topology of FIG. 1A simplified with diodes substituting some of the MOSFET switches, which is made possible due to unidirectional operation of the converter.

FIG. 1C schematically illustrates the MMSPC topology of FIG. 1B simplified further by shorting the devices in a permanently ON state and removing devices in a permanently OFF state.

FIG. 1D schematically illustrates the MMSPC topology of FIG. 1C rearranged for clarity, wherein FIGS. 1A-1D illustrate the simplification progress from a conventional MMSPC (FIG. 1A) to the power electronic converter of the present disclosure (FIG. 1D).

FIG. 2 schematically illustrates an implementation of the disclosed power electronic converter in an auxiliary power supply.

FIG. 3 schematically illustrates the power electronic converter according to the present disclosure.

FIGS. 4A-4H schematically illustrate the operating modes of the power electronic converter of FIG. 3, wherein FIG. 4A is Mode 0: bypass connection, FIGS. 4B-4D are Mode 1: combination of series/parallel/bypass connections on modules, FIGS. 4E-4G are Mode 2: combination of series/parallel/bypass connections on modules, and FIG. 4H is Mode 3: series connection of all modules.

### DETAILED DESCRIPTION

The present disclosure embraces a power electronic converter which is derived from MMSPC. The MMSPC's topology is a generalization of a conventional modular multilevel converter (MMC) topology, and allows not only series but also parallel connections among modules. One advantage of the MMSPC over MMC is the modules' voltages are balanced without sensing. Another advantage of the MMSPC is a reduction in the current rating necessary for each switch in the MMSPC. Each switch in the MMSPC requires half the current rating required for a switch in a conventional MMC.

Additionally, the MMSPC features an internal capacitor voltage balancing and requires only one dc-link voltage sensor to perform the required control. Even at light load operation (when the input current is relatively small), a PFC may be used to achieve a unity power factor (PF) and a low total harmonic distortion (THD) of the input current. The MMSPC may be used easily with a predictive PFC control algorithm. The power electronic converter disclosed herein retains all the advantages of the MMSPC. The disclosed power electronic converter has an advantage of significantly reduced number of power semiconductor devices, compared to the MMSPC.

Although a MMSPC is capable of bidirectional operation, some applications, such as a power supply, require only unidirectional power flow (i.e., from the HV ac input to the dc output). While other unidirectional applications may exist, the power supply application is considered for convenience in what follows.

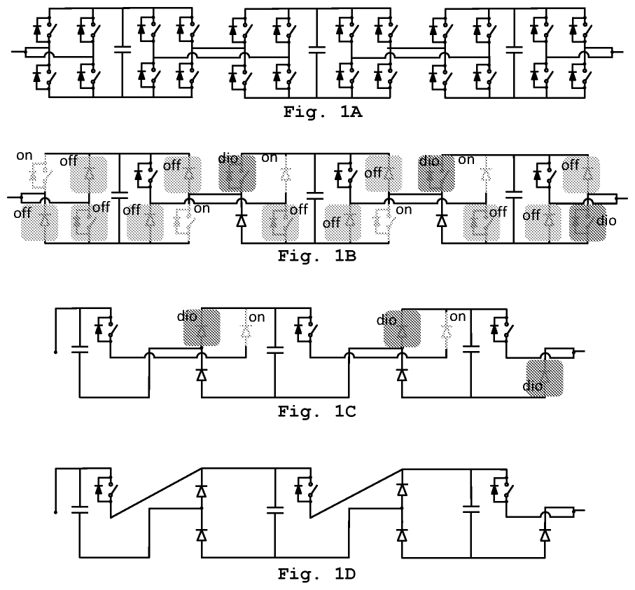

As shown in FIGS. 1A and 1B, unidirectional power flow implies that only bypass connection, parallel connections, and series connection with negative polarities are used. This allows for the substitution of diodes for some of the MOSFETs, as shown in FIGS. 1A and 1B. Further, it can be noticed that, in operation, some of the devices would always stay in the ON state, while some of the devices would always remain in the OFF state. Those devices that would stay in the ON state (i.e., devices marked yellow and/or the word “on” in FIG. 1B) can be replaced with a short circuit, whereas those that would always remain OFF (i.e., devices marked green and/or the word “off” in FIG. 1B) can be completely removed from the circuit. Additionally, some MOSFETs (i.e., marked red and/or the letters “dio” in FIG. 1B) can be replaced by diodes because they need to conduct only when their body diodes would naturally conduct (e.g., in the absence of the gate signal). This replacement, as shown in FIG. 1C, further simplifies the topology. The topology can be rearranged for clarity as shown in FIG. 1D.

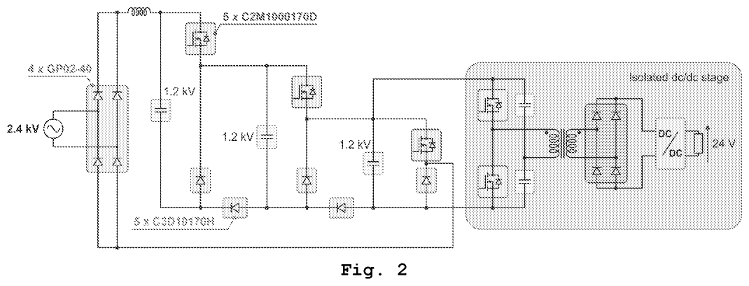

An auxiliary power supply based on the disclosed power electronic converter is shown in FIG. 2. In addition to the disclosed power electronic converter, a dc/dc power converter is connected to the output of the disclosed power electronic converter to provide the galvanic isolation of the regulated output voltage, as shown in FIG. 2. The disclosed power electronic converter has similar topology to known switched capacitor (SC) converters, but differs in the way the series/parallel connections are achieved and in the modulation strategy. The topology of the disclosed power electronic converter is fully scalable and can adapt to higher MV input voltage by simply increasing the number of series connected modules.

### DISCLOSED POWER ELECTRONIC CONVERTER OPERATING PRINCIPLE

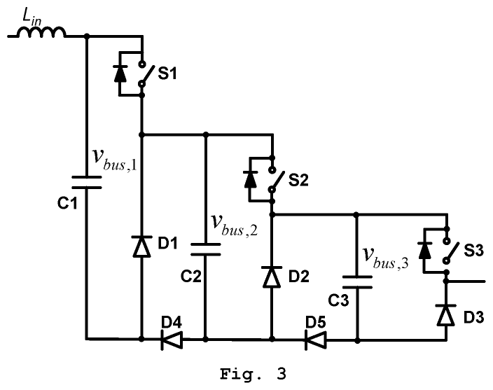

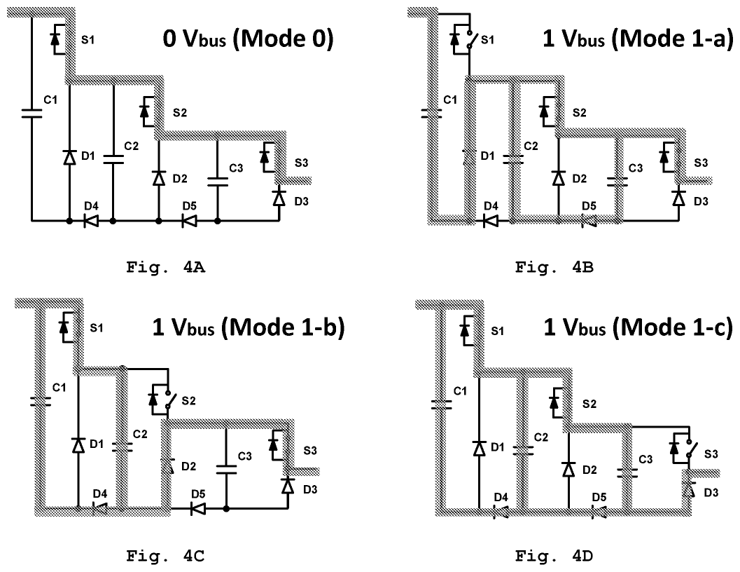

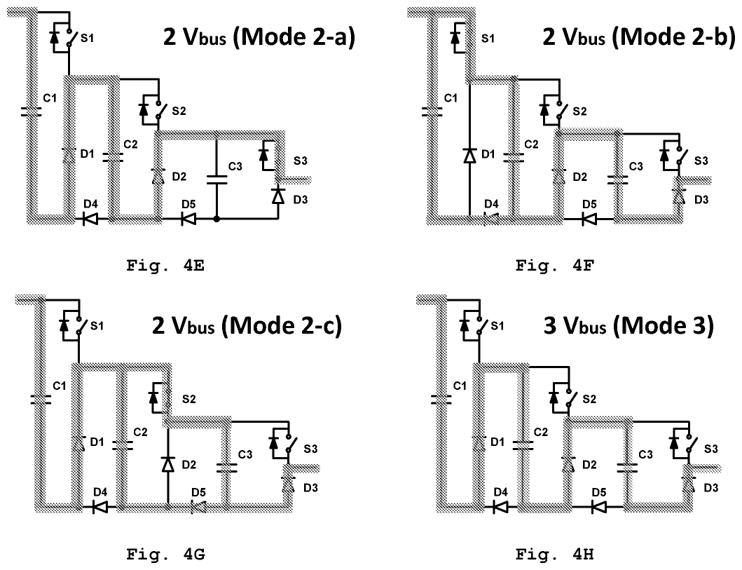

FIG. 3 schematically illustrates the power electronic converter of the present disclosure. The disclosed power electronic converter has four operating modes. The operating modes are schematically illustrated in FIGS. 4A-4H. As shown in FIGS. 4A-4H, the disclosed power electronic converter can produce 0V, 1×Vbus, 2×Vbus, or 3×Vbus at the right-hand side of the input inductor (Lᵢₙ) by connecting the dc bus capacitors in series or in parallel.

The Table I lists balancing effect according to the switching states of the four different operating modes of the disclosed power electronic converter. The parallel connection of modules (dc bus capacitors) can be used to improve the dc-link voltages balancing and only one dc-link voltage sensor is required (at the C3 in FIG. 3). No other balancing control is necessary.

TABLE I
BALANCING EFFECT ACCORDING TO SWITCHING STATE

| | Switching | Balancing | Composed | |
|---|---|---|---|---|
| Mode | state | effect | voltage | Connection |
| 0 | (1, 1, 1) | — | 0 V | 3B |
| 1-a | (0, 1, 1) | V_{bus, 2}, V_{bus, 3} | | 1S + 2B |
| 1-b | (1, 0, 1) | V_{bus, 1}, V_{bus, 2} | 1 V_{bus} | 2P + 1B |
| 1-c | (1, 1, 0) | V_{bus, 1}, V_{bus, 2}, V_{bus, 3} | | 3P |
| 2-a | (0, 0, 1) | — | 2 V_{bus} | 2S + 1B |
| 2-b | (1, 0, 0) | V_{bus, 1}, V_{bus, 2} | | 2P + 1S |
| 2-c | (0, 1, 0) | V_{bus, 2}, V_{bus, 3} | | 1S + 2P |
| 3 | (0, 0, 0) | — | 3 V_{bus} | 3S |

(B: bypass, S: series connection, P: parallel connection)

The equations that describe the input inductor's current slope in each of the 4 modes illustrated in FIGS. 4A-4H are presented in Table II. Due to the interleaved PWM scheme applied in this case, there are three distinct regions of the input voltage and three intervals of duty cycle, d, in which only certain operating modes can be applied, as shown in Table II.

TABLE II
OPERATING REGIONS AND CORRESPONDING MODES OF THE
PROPOSED CONVERTER TOPOLOGY

| Range | Duty | Mode | Current Ripple slope | |
|---|---|---|---|---|
| Region 1 \|vᵢₙ\| < V_{bus} | $\frac{2}{3} \leq d < 1$ | Mode 0, 1 | $up \text{:} \frac{\vert {v}_{in} \vert}{L}$ | $d own \text{:} \frac{\vert {v}_{in} \vert - {v}_{bus}}{L}$ |
| Region 2 V_{bus} < \|vᵢₙ\| < 2V_{bus} | $\frac{1}{3} \leq d < \frac{2}{3}$ | Mode 1, 2 | $up \text{:} \frac{\vert {v}_{in} \vert - {v}_{bus}}{L}$ | $d own \text{:} \frac{\vert {v}_{in} \vert - 2 {v}_{bus}}{L}$ |
| Region 3 2V_{bus} < \|vᵢₙ\| < 3V_{bus} | $0 \leq d < \frac{1}{3}$ | Mode 2, 3 | $up \text{:} \frac{\vert {v}_{in} \vert - 2 {v}_{bus}}{L}$ | $d own \text{:} \frac{\vert {v}_{in} \vert - 3 {v}_{bus}}{L}$ |

Region 1: In this region, the equivalent circuit is changing between Mode 0 and Mode 1 (see FIGS. 4A and 4B-4D). This means that the converter has all bypass connections or all parallel connections. In Mode 0, due to the all bypass connections, the inductor sees a positive voltage of |Vᵢₙ|, resulting in increasing inductor current. On the other hand, in mode 1, the inductor sees the negative voltage of |Vᵢₙ|−V_{bus} (because |Vᵢₙ| is lower than V_{bus}). In this mode, the inductor current decreases. Even though Mode 1 can have switching states other than (1,1,0) (i.e., as shown in FIG. 4D), all these states would produce the same inductor current ripple and can be described by the following two equations:

$$\begin{matrix}Δ {i}_{L \_ up} = \frac{\vert {v}_{in} \vert}{{Lf}_{s}} ( d - \frac{2}{3} ) & ( 1 ) \\ Δ {i}_{L \_ down} = \frac{{v}_{bus} - \vert {v}_{in} \vert}{{Lf}_{s}} ( 1 - d ) & ( 2 )\end{matrix}$$

where d is the duty cycle and fₛ is the switching frequency.

Region 2: In this region, the modules' connections are changing between Mode 1 and Mode 2 (see FIGS. 4B-4D and 4E-4G). In Mode 2, the inductor sees a negative voltage of |Vᵢₙ|−2V_{bus}, resulting in decreasing of the inductor current. In this region, the inductor current ripple can be described by the following two equations:

$$\begin{matrix}Δ {i}_{L \_ up} = \frac{\vert {v}_{in} \vert - {v}_{bus}}{{Lf}_{s}} ( d - \frac{1}{3} ) & ( 3 ) \\ Δ {i}_{L \_ down} = \frac{2 {v}_{bus} - \vert {v}_{in} \vert}{{Lf}_{s}} ( \frac{2}{3} - d ) & ( 4 )\end{matrix}$$

Region 3: In this region, the modules' connections are changing between Mode 2 and Mode 3 (see FIGS. 4E-4G and 4H). The analysis of Mode 2 is same as Region 2. In Mode 3, the inductor sees a negative voltage of |Vᵢₙ|−3V_{bus}. In this region, the inductor current ripple can be described by the following two equations:

$$\begin{matrix}Δ {i}_{L \_ up} = \frac{\vert {v}_{in} \vert - 2 {v}_{bus}}{{Lf}_{s}} d & ( 5 ) \\ Δ {i}_{L \_ down} = \frac{3 {v}_{bus} - \vert {v}_{in} \vert}{{Lf}_{s}} ( \frac{1}{3} - d ) & ( 6 )\end{matrix}$$

In the specification and/or figures, typical embodiments have been disclosed. Those skilled in the art will also appreciate that various adaptations and modifications of the preferred and alternative embodiments described above can be configured without departing from the scope and spirit of the disclosure.

1. A cascaded modular multilevel converter for medium-voltage power electronics systems, comprising:
a plurality of modules, wherein each module has a bus capacitor, a diode and a switch so that the bus capacitors between modules may be connected in series or in parallel depending on the state of the switches in the modules.

2. The power electronic converter according to claim 1, wherein an input voltage of the power electronic converter corresponds to the number of modules in the plurality.

3. The power electronic converter according to claim 1, wherein the converter has a first number (N) of modules, and wherein the converter has a second number (N+1) of modes of operation based on the state of the switch in each of the N modules.

4. The power electronic converter according to claim 3, wherein a composed voltage of the converter is number (m) (where 0≤m≤N) times a bus capacitor voltage when N−m of the N modules have closed (ON) switches and m of the N modules have an open (OFF) switch.

5. The power electronic converter of claim 1, further comprising a dc/dc power converter wherein the dc/dc power converted is connected to an output of the power electronic converter to provide galvanic isolation of a regulated output voltage.

6. The power electronic converter of claim 1, wherein the power electronic converter has an input voltage and an output voltage.

7. The power electronic converter of claim 6, wherein the input voltage is 2.4 kV RMS and the output voltage is 24 V dc.

8. The power electronic converter of claim 7, wherein the power electronic converter has a power rating of 100 Watts with 10kV of isolation.
